(19) United States
(12) Patent Application Publication
(10) Pub. No.: US 2025/0187499 A1
(43) Pub. Date: Jun. 12, 2025

(54) TRACK ASSEMBLY

(71) Applicant: Lear Corporation, Southfield, MI (US)

(72) Inventors: Herve Benezit, Roche-la-Molière (FR); Antoine Moulin, Aurec-Sur-Loire (FR)

(73) Assignee: Lear Corporation, Southfield, MI (US)

(21) Appl. No.: 18/532,738

(22) Filed: Dec. 7, 2023

(51) Int. Cl. B60N 2/06

(52) U.S. Cl. CPC B60N 2/067

(57) ABSTRACT

A track assembly, comprising a track including teeth; and a support assembly slidably connected to the track. The support assembly includes a rotatable shaft disposed at least partially in the track, a first worm coupled with the rotatable shaft and engaged with the teeth; and a second worm coupled with the rotatable shaft and movable relative to the first worm, the second worm engaged with the teeth.

### TECHNICAL FIELD

The present disclosure generally relates to track assemblies, including track assemblies that can, for example, be utilized in connection with vehicle seats.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a track assembly according to teachings of the present disclosure.

FIG. 2 is a perspective view generally illustrating an embodiment of a track assembly according to teachings of the present disclosure.

FIG. 3 is a rear view generally illustrating an embodiment of a track assembly according to teachings of the present disclosure.

FIG. 4 is a perspective view generally illustrating portions of an embodiment of a track assembly according to teachings of the present disclosure.

FIG. 5 is a perspective view generally illustrating portions an embodiment of a track assembly, with other portions hidden, according to teachings of the present disclosure.

FIGS. 6 and 7 are perspective views generally illustrating an embodiment of a rotatable shaft according to teachings of the present disclosure.

FIGS. 8 and 9 are perspective views generally illustrating an embodiment of a worm according to teachings of the present disclosure.

FIG. 10A is an exploded perspective view generally illustrating an embodiment of a drive assembly according to teachings of the present disclosure.

FIG. 10B is a perspective view generally illustrating the embodiment of the drive assembly of FIG. 10A in an assembled configuration.

FIG. 11 is a top view generally illustrating portions an embodiment of a track assembly, with other portions hidden, according to teachings of the present disclosure.

FIG. 12 is a schematic cross-sectional view generally illustrating portions of an embodiment of a track assembly, with a drive assembly in a stopped/idle state, according to teachings of the present disclosure.

FIG. 13 is a schematic cross-sectional view generally illustrating portions of embodiment of first and second worms and a rotatable shaft of a track assembly, with the first and second worms in a first relative position, according to teachings of the present disclosure.

FIG. 14 is a schematic cross-sectional view generally illustrating portions of an embodiment of a track assembly, with a drive assembly in an operating state, according to teachings of the present disclosure.

FIG. 15 is a schematic cross-sectional view generally illustrating portions of embodiment of first and second worms and a rotatable shaft of a track assembly, with the first and second worms in a second relative position, according to teachings of the present disclosure.

FIG. 16 is an end view generally illustrating portions an embodiment of a track assembly, with other portions hidden, according to teachings of the present disclosure.

FIG. 17 is a perspective view generally illustrating portions an embodiment of a track assembly, with other portions hidden, according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

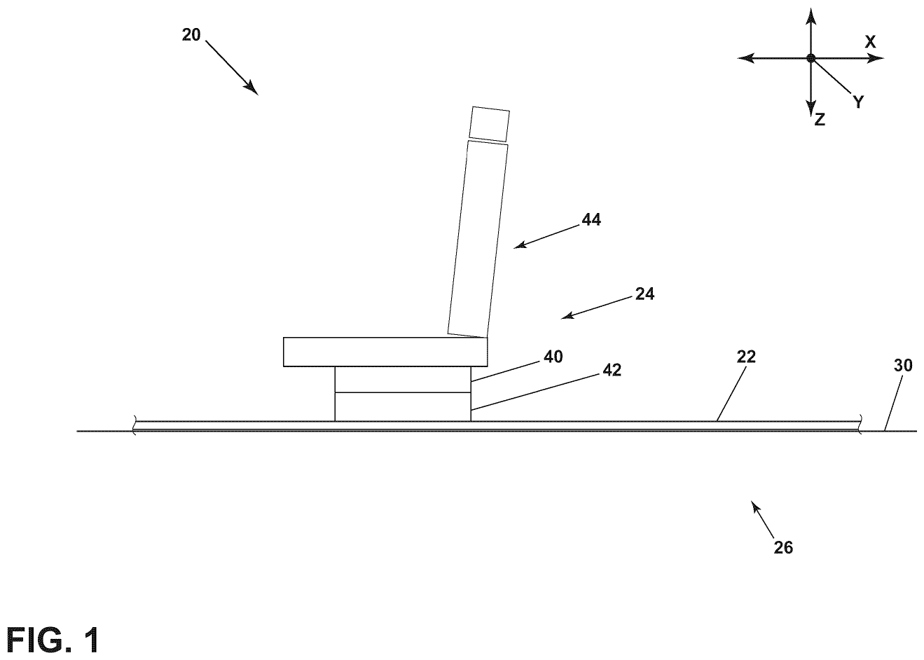

Referring to FIG. 1, a track assembly 20 is illustrated with a pair of tracks 22 and a support assembly 24. The pair of tracks 22 is coupled with a mounting surface 30, which can include a vehicle surface, such as a vehicle floor, among other surfaces. The support assembly 24 is movably (e.g., slidably) connected with the mounting surface 30 via the pair of tracks 22. The support assembly 24 includes a support body 40 and a pair of base portions 42. The pair of base portions 42 are movably (e.g., slidably) connected to the pair of tracks 22, such as to slidably connect the support assembly 24 with the pair of tracks 22. The support body 40 is connected to and moves with the pair of base portions 42. A component 44, such as a seat, a console, or a storage rack, among others, can be connected to and at least partially supported by the support body 40. Optionally, the track assembly 20 is included with a vehicle 26.

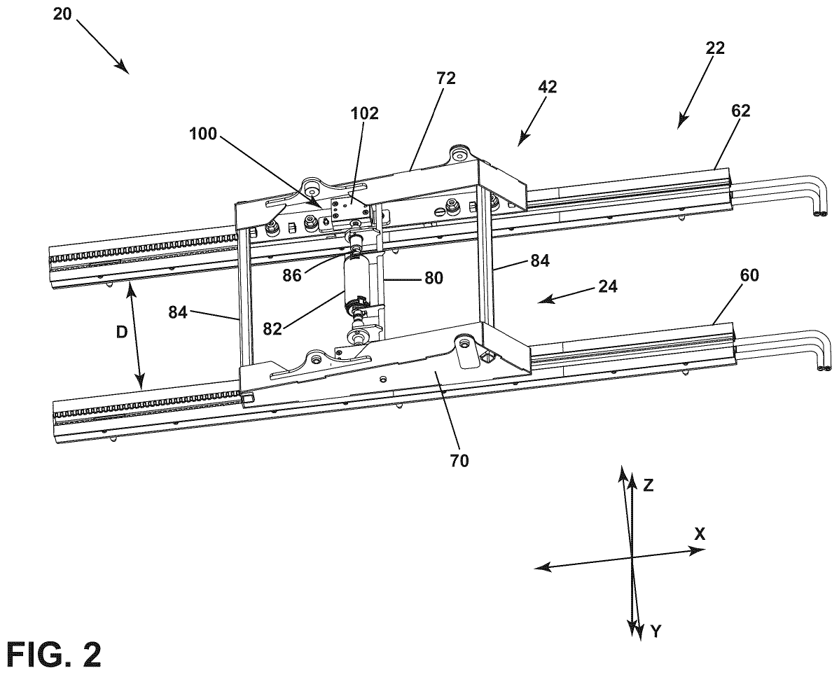

Referring to FIG. 2, the pair of tracks 22 includes a first track 60 spaced from a second track 62, such as in a transverse direction Y. The pair of base portions 42 includes a first base portion 70 movably connected to the first track 60 and includes a second base portion 72 movably connected to the second track 62. A motor bracket 80 is connected to the first base portion 70 and the second base portion 72 to support a motor 82. Optionally, a set of cross members 84 are connected to the first and second base portions 70, 72.

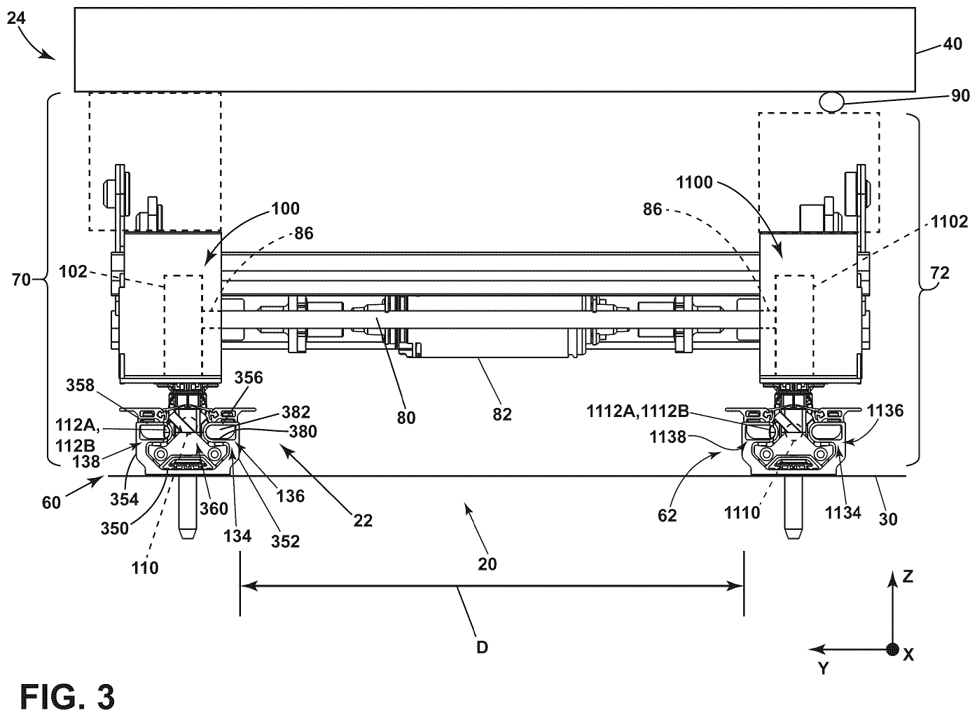

Referring to FIG. 3, the first base portion 70 is engaged with the first track 60 and is fixed (e.g., rigidly) with the support body 40 such that the support body 40 does not move to material extent relative to the first base portion 70. The second base portion is engaged with the second track 62 and is movably (e.g., rotatably) coupled with the support body 40 such that the support body 40 can move, at least to some extent, relative to the second base portion 72 (and vice versa). For example, a coupling 90 (e.g., a rotational or pivot coupling) can provide a movable connection (e.g., a rotatable connection) between the second base portion 72 with the support body 40.

With some embodiments, the first and second tracks 60, 62 can be disposed in parallel with each other and define a longitudinal direction X. In some instances, such as due to manufacturing and/or assembly tolerances, the first and second tracks 60, 62 may not be exactly straight or parallel along their entire lengths, which may result in the distance D between the first and second tracks 60, 62 in a transverse direction Y varying, at least to some extent. For example and without limitation, the actual value of the distance D may vary by up to 1.5% of a nominal value of the distance D. In some non-limiting examples, the nominal value of the distance D can be 300 mm and the actual value of the distance D may range from 296.5 mm to 303.5 mm. The rotational connection between the second base portion 72 and the support body 40 can allow the track assembly 20 to at least partially compensate for variances in the distance D. For example, when the second base portion 72 is positioned at a portion of the second track 62 disposed farther from the first track 60 than the nominal value of the distance D, the second base portion 72 may rotate away from the first track 60, at least to some degree. When the second base portion 72 is positioned at a portion of the second track 62 disposed closer to the first track 60 than the nominal value of the distance D, the second base portion 72 may rotate toward from the first track 60, at least to some degree. This rotation of the second base portion 72 can help keep the second base portion 72 aligned with the second track 62 and/or parallel with the longitudinal direction X. Variances in the distance D can be more common with longer tracks 60, 62. In some configurations, the tracks 60, 62 can be at least two meters long (e.g., less than, equal to, or greater than three meters), but can include other lengths, such as less then or equal to one meter and greater than or equal to half of a meter.

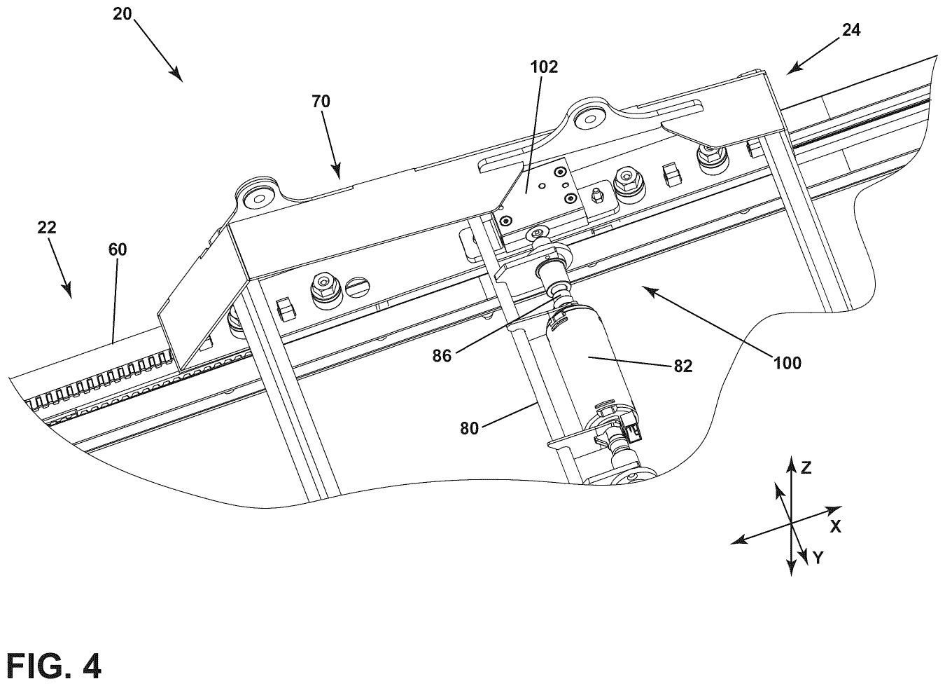

Referring to FIG. 4, the first base portion 70 includes a first drive assembly 100. The first drive assembly 100 includes a transmission 102 operably coupled with the motor 82, such as with a drive shaft 86 of the motor 82. The transmission 102 is disposed at least partially above the first track 60.

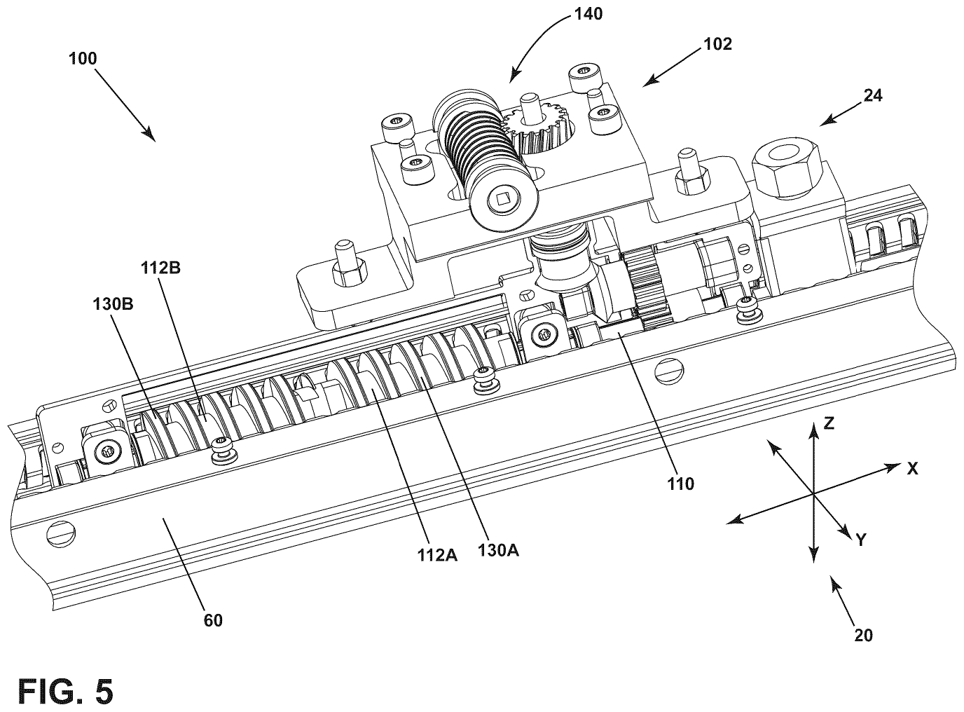

Referring to FIG. 5, the drive assembly 100 further comprises a rotatable shaft 110, a first worm 112A, and a second worm 112B. The transmission 102 includes a set of gears 140 arranged to transfer rotational forces of the motor 82 to the rotatable shaft 110. The set of gears 140 can include one or more gears disposed at least partially in the first track 60 and/or one or more gears disposed at least partially outside (e.g., above) the first track 60. The motor 82 may be aligned with and/or include a drive shaft 86 that rotates about an axis aligned with the transverse direction Y. The rotatable shaft 110 may be aligned with the longitudinal direction X and/ore centered in the first track 60. The transmission 102 transfers/converts the transverse direction rotation of the motor 82 to the longitudinal direction rotation of the rotatable shaft 110 such that operation of the motor 82 rotates the rotatable shaft 110.

The rotatable shaft 110 is rotatably coupled with the first base portion 70 and is disposed at least partially in the first track 60. The first worm 112A and the second worm 112B are disposed on the rotatable shaft 110. The first worm 112A and/or the second worm 112B is movably connected to the rotatable shaft 110. For example, at least one of the first worm 112A or the second worm 112B can move (e.g., rotate) with and move (e.g., rotate and/or translate) relative to the rotatable shaft 110. The first worm 112A includes first worm threads 130A. The second worm 112B includes second worm threads 130B. The first track 60 includes first track teeth 134. The threads 130A, 130B of the first and second worms 112A, 112B are engaged with the first track teeth 134.

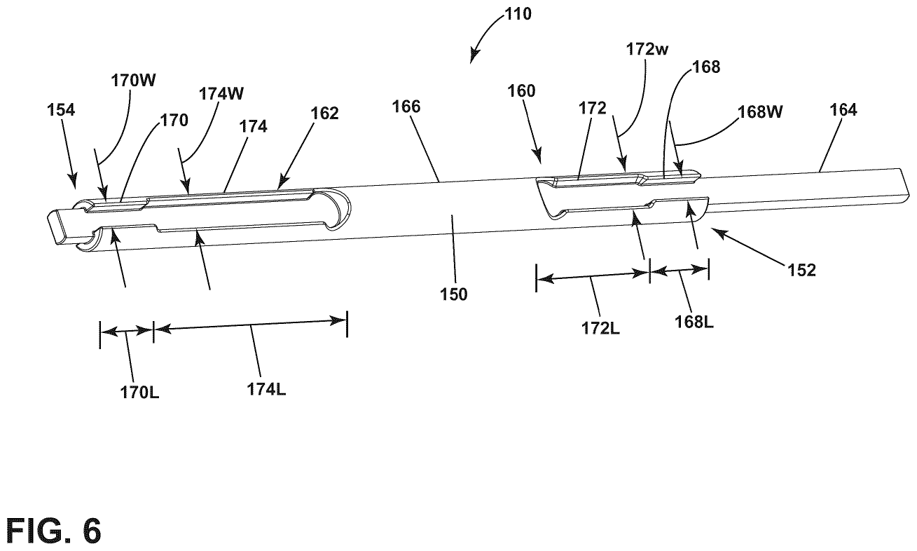

Referring to FIG. 6, the rotatable shaft 110 includes a body 150, a first recess 160, a second recess 162, a drive portion 164, and an outer surface 166. The drive portion 164 extends from a first end 152 of the body 150 and is operably coupled with the transmission 102 (FIG. 5) for rotation of the rotatable shaft 110. At least a portion of the outer surface 166, such as proximate a second end 154 of the body 150 is supported by the first base portion 70, such as by a bearing thereof.

The first recess 160 and the second recess 162 are formed in the outer surface 166 (e.g., the outer radial surface) of the rotatable shaft 110 and extend in the axial and circumferential directions of the rotatable shaft 110. The recesses 160, 162 can include narrow portions 168, 170 and wide portions 172, 174, relative to the circumferential direction. The narrow portions 168, 170 extend axially inward from the ends 152, 154 of the body 150. The wide portions 172, 174 extend axially inward from the narrow portions 168, 170. The narrow portions 168, 170 have widths 168W, 170W (e.g., circumferential dimensions) and lengths 168L, 170L (e.g., axial dimensions). The wide portions 172, 174 have widths 172W, 174W and lengths 172L, 174L. The widths 172W, 174W are wider than the widths 168W, 170W, and/or the lengths 172L, 174L are longer than the lengths 168L, 170L. Optionally, the length 172L is shorter than the length 174L. The lengths 168L, 170L may be the same.

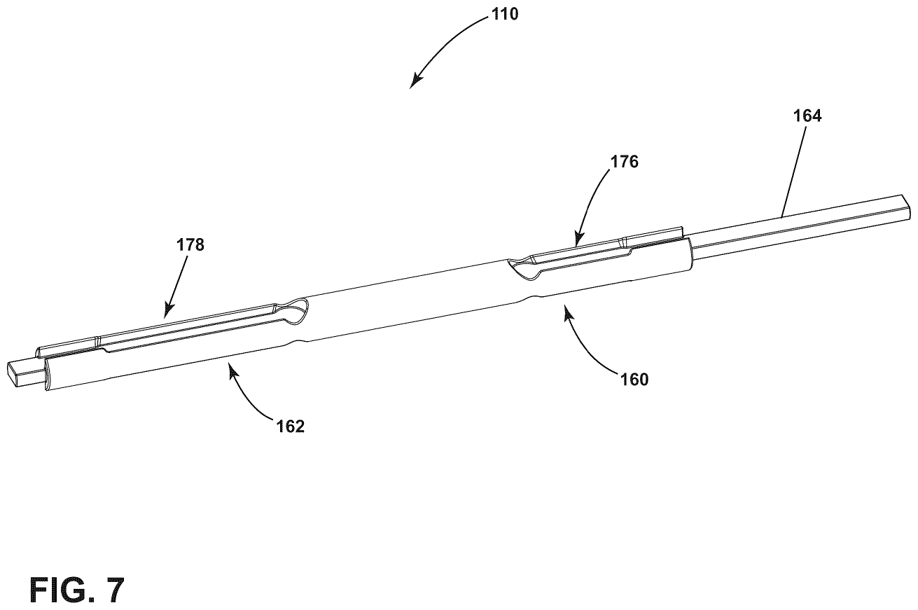

Optionally, as illustrated in FIG. 7, the rotatable shaft 110 includes a third recess 176 circumferentially offset from the first recess 160, and/or includes a fourth recess 178 circumferentially offset from the second recess 162. The third recess 176 is configured in a similar or the same manner as the first recess 160. The fourth recess 178 is configured in a similar or the same manner as the second recess 162.

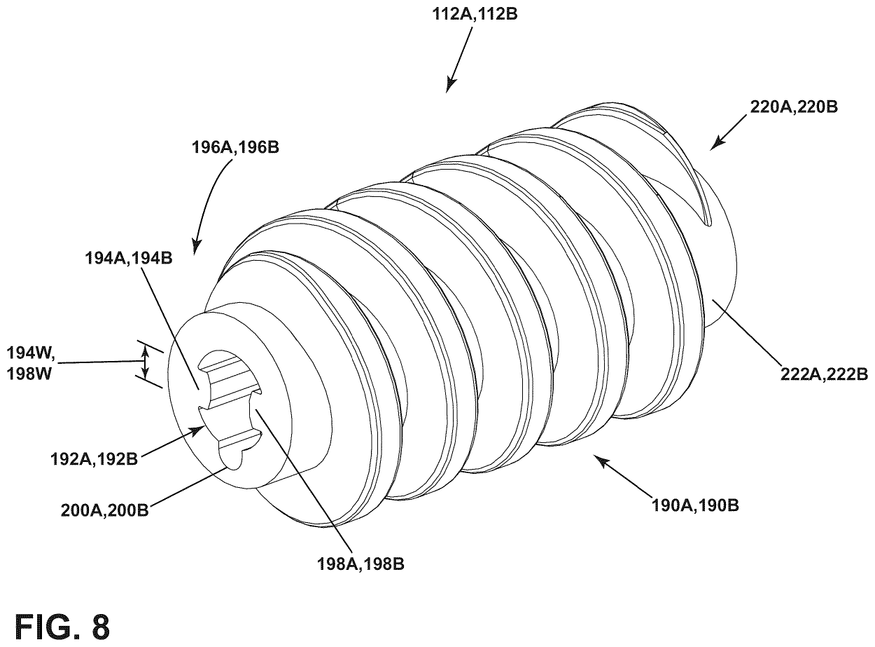

Referring to FIG. 8, a worm, such as the first worm 112A or the second worm 112B is illustrated. The worms 112A, 112B include a worm body 190A, 190B, respectively, and have an aperture 192A, 192B through which the rotatable shaft 110 is inserted. The worm body 190A, 190B includes a protrusion 194A, 194B that extends (e.g., radially inward) into the through aperture 192A, 192B and has a width 194W (e.g., a circumferential dimension). The protrusion 194A, 194B can be disposed at a first end 196A, 196B of the worm body 190A, 190B. Optionally, the worm body 190A, 190B can include a second protrusion 198A, 198B disposed at the first end 196A, 196B and circumferentially offset from the protrusion 194A, 194B and having a width 198W. For example, centers of the protrusions 194A, 194B can be offset from centers of the protrusions 198A, 198B by 180 degrees, but can include other configurations. The worm body 190A, 190B includes a channel 200A, 200B at the first end 196A, 196B that extends radially outward from the through aperture 192A, 192B and is circumferentially offset from the protrusion 194A, 194B and/or the second protrusion 198A, 198B. The threads 130A, 130B can extend outward (e.g., radially outward) from the worm body 190A, 190B.

The wide portions 172, 174 of the recesses 160, 162 (FIG. 6) have at least one dimension that is larger than a corresponding dimension of the protrusions 194A, 194B. For example, the widths 170W, 174W (FIG. 6) can be wider than the width 194W. Additionally or alternatively, the recesses 160, 162 (FIG. 6) can be longer in the axial direction of the rotatable shaft 110 than the protrusions 194A, 194B. The recesses 176, 178 can be configured in an analogous manner relative to the protrusions 198A, 198B.

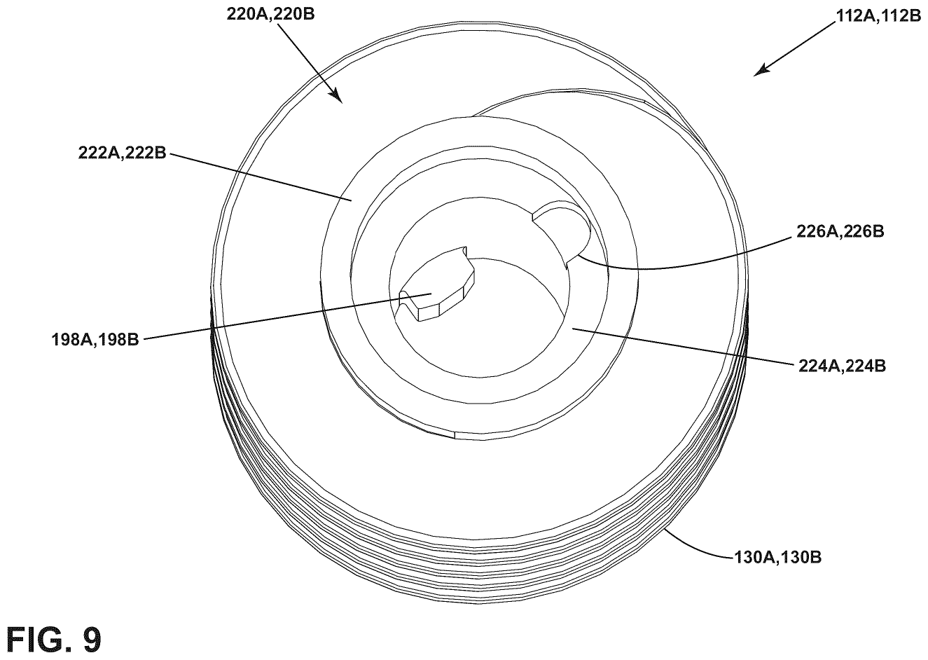

Referring to FIG. 9, a second end 220A, 220B of the worm body 190A, 190B is illustrated. The second end 220A, 220B can define a sleeve portion 222A, 222B, a shoulder 224A, 224B (e.g., an axial surface), and a shoulder recess 226A, 226B. The sleeve portion 222A, 222B extends axially outward from the shoulder 224A, 224B. The shoulder recess 226A, 226B extends axially into the shoulder 224A, 224B.

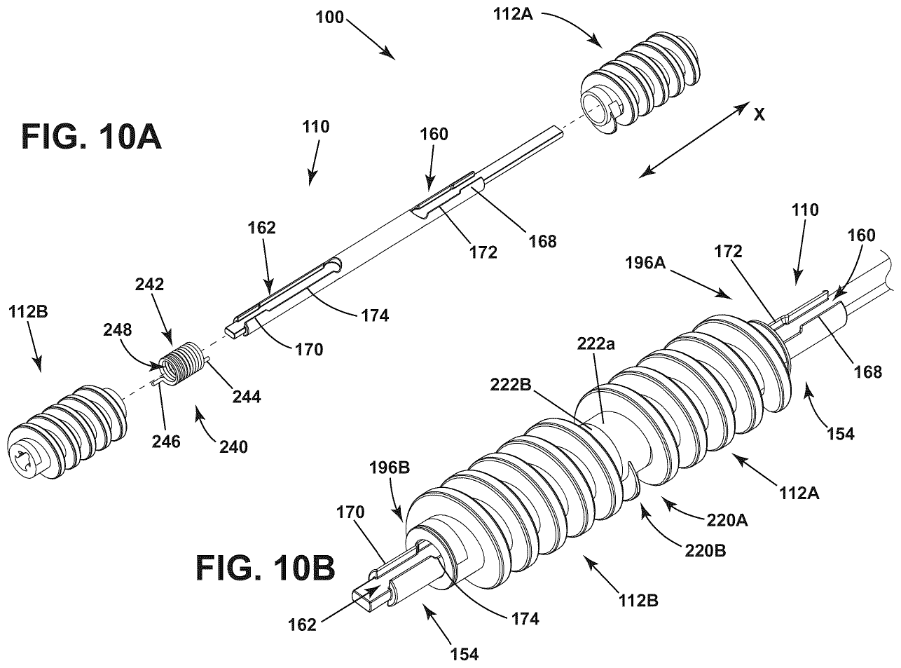

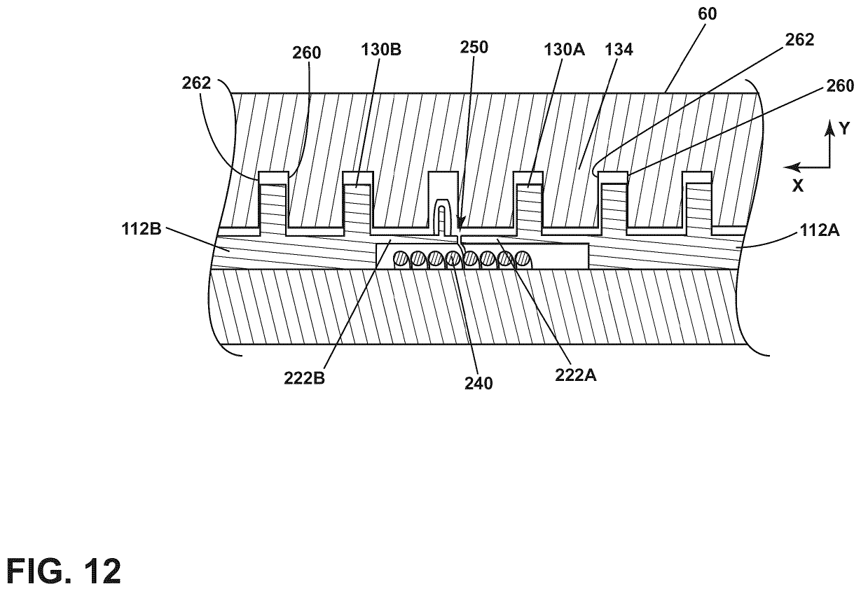

Referring to FIG. 10A, portions of the first drive assembly 100, including the rotatable shaft 110, the first worm 112A, the second worm 112B, and a spring 240 are illustrated. The spring 240 can, for example include a torsion spring and can include spring body 242, a first arm 244, and a second arm 246. The spring body 242 can include windings wound around a central axis of the spring 240 such that the spring body 242 is hollow and defines a spring passage 248 through which the rotatable shaft 110 is insertable. The first arm 244 extends toward the first worm 112A and the second arm 246 extends toward the second worm 112B. The outer dimensions (e.g., outer diameter) of the spring body 242 can be smaller than the inner dimensions of the sleeve portions 222A, 222B of the worms 112A, 112B such that, in an assembled configuration, some, most, or all of the spring body 242 is disposed in one or both of the sleeve portions 222A, 222B of the worms 112A, 112B (see, e.g., FIG. 12).

Referring to FIG. 10B, the rotatable shaft 110 is inserted through the first worm 112A, the spring 240, and the second worm 112B. Inserting the rotatable shaft 110 into the first worm 112A includes aligning (e.g., circumferentially) the protrusion 194A of the first worm 112A with the narrow portion 168 of the first recess 160, sliding the first worm 112A along the rotatable shaft 110 such that the protrusion 194A (FIG. 8) slides through the narrow portion 168 and into the wide portion 174. In embodiments with the rotatable shaft 110 including the third recess 176 (FIG. 7) and the first worm 112A including the second protrusion 198A (FIG. 8), inserting the rotatable shaft 110 into the first worm 112A can also include aligning the second protrusion 198A with the third recess 176 when aligning the protrusion 194A with the first recess 160. Additionally or alternatively, the second protrusion 198A may slide along the third recess 176 as the protrusion 194A slides through the first recess 160. The rotatable shaft 110 can be inserted into the spring 240 such that the spring 240 is wrapped at least partially around the rotatable shaft 110. The rotatable shaft 110 can be inserted into the second worm 112B in a similar manner as the first worm 112A. For example, the protrusion 194B of the second worm 112B can be inserted into the narrow portion 170 of the second recess 162 and the second worm 112B can be moved farther (e.g., toward the first worm 112A) such that the protrusion 194B of the second worm 112B slides into the wide portion 174.

In the assembled configuration, the second ends 220A, 220B and the sleeve portions 222A, 222B of the worms 112A, 112B can be adjacent to each other. For example, the worms 112A, 112B can be disposed in a mirrored configuration with the second ends 220A, 220B of the worms 112A, 112B disposed at a middle section of the rotatable shaft 110, the first end 196A of the first worm 112A disposed proximate the first end 152 of the shaft body 150, and the first end 196B of the second worm 112B disposed proximate the second end 154 of the shaft body 150.

In the assembled configuration, the spring 240 (FIG. 10A) biases the worms 112A, 112B away from each other toward a first relative position, which can include rotationally biasing the worms 112A, 112B in opposite directions. For example, the first arm 244 of the spring 240 (FIG. 10A) can be disposed at least partially in the shoulder recess 226A (FIG. 9) of the first worm 112A, and/or the second arm 246 of the spring 240 (FIG. 10A) can be disposed at least partially in the shoulder recess 226B (FIG. 9) of the second worm 112B to rotationally bias the worms 112A, 112B away from each other.

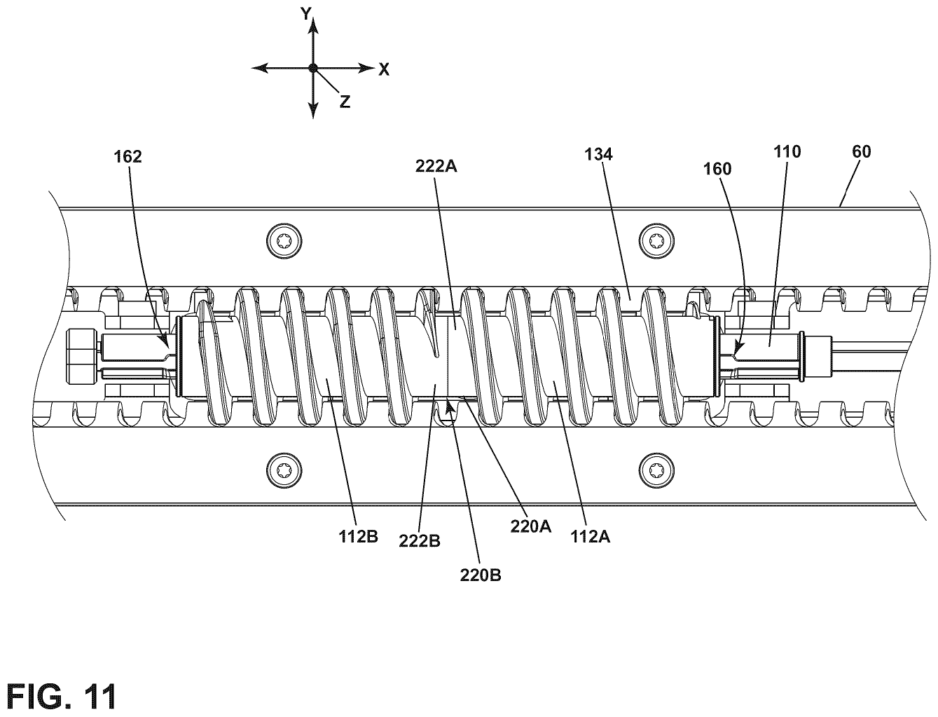

The widths 172W, 174W (FIG. 6) of the wide portions 172, 174 are wider than the widths 194W, of the protrusions 194A, 194B (FIG. 8) of the worms 112A, 112B such that the worms 112A, 112B are movable (e.g., rotatable and/or translatable) relative to the rotatable shaft 110. For example, when the motor 82 is not active (e.g., in a stopped or idle state of the first drive assembly 100), the spring 240 rotates at least one of the first worm 112A or the second worm 112B away from the other, which can include the protrusion(s) 194A, 194B moving within the wide portion 172, 174. The movement of the worm(s) 112A, 112B can include rotational movement about the rotatable shaft 110 and/or translational movement along the rotatable shaft 110. For example, threads 130A, 130B of the worms 112A, 112B are engaged with the first track teeth 134 such that rotational movement of the worm(s) 112A, 112B caused by the spring 240 can result in translation of the worm(s) 112A, 112B along the rotatable shaft 110, at least some degree. This translational movement can result in an axial gap 250 (FIG. 11) between the worms 112A, 112B in the stopped/idle state of the drive assembly 100. In the stopped/idle state of the drive assembly 100, the worms 112A, 112B are disposed in the first relative position (e.g., axially offset and thread pitch offset). The relative movement of the worms 112A, 112B caused by the spring 240 can offset the pitch of the threads 130A, 130B of the first worm 112A from the pitch of the threads 130A, 130B of the second worm 112B. When the worms 112A, 112B are rotating together with the rotatable shaft 110, such as when the motor 82 is operating to drive the rotatable shaft 110, which may define a second relative position of the worms 112A, 112B, the threads 130A of the first worm 112A can be aligned with and match the pitch of the threads 130B of the second worm 112B.

Referring to FIG. 11, the rotatable shaft 110, the first worm 112A, and the second worm 112B is inserted partially into the first track 60 such that the threads 130A, 130B of the worms 112A, 112B are engaged with first track teeth 134.

Referring to FIG. 12, when the motor 82 is not operating, the spring 240 rotates the spring 240 rotates at least one of the first worm 112A or the second worm 112B away from the other toward the first relative position, such as until frictional forces between the worm(s) 112A, 112B and the first track teeth 134 are greater than the spring force, which can lock the support assembly 24 with first track 60. Such movement of the worm(s) 112A, 112B can result in the threads 130A of the first worm 112A being in contact with first axial surfaces 260 of the first track teeth 134 and/or the threads 130B of the second worm 112A being in contact with second axial surfaces 262 of the first track teeth 134. The axial surfaces 260, 262 are disposed at opposite sides of the first track teeth 134 in the longitudinal direction X. Such contact with opposite sides of the first track teeth 134 can lock the support assembly 24 with the first track 60 and/or restrict or eliminate play between the support assembly 24 and the first track 60 in the longitudinal direction X. Additionally, in the first relative position, the threads 130A can be offset from the second axial surfaces 262, and the threads 130B can be offset from the first axial surfaces 260.

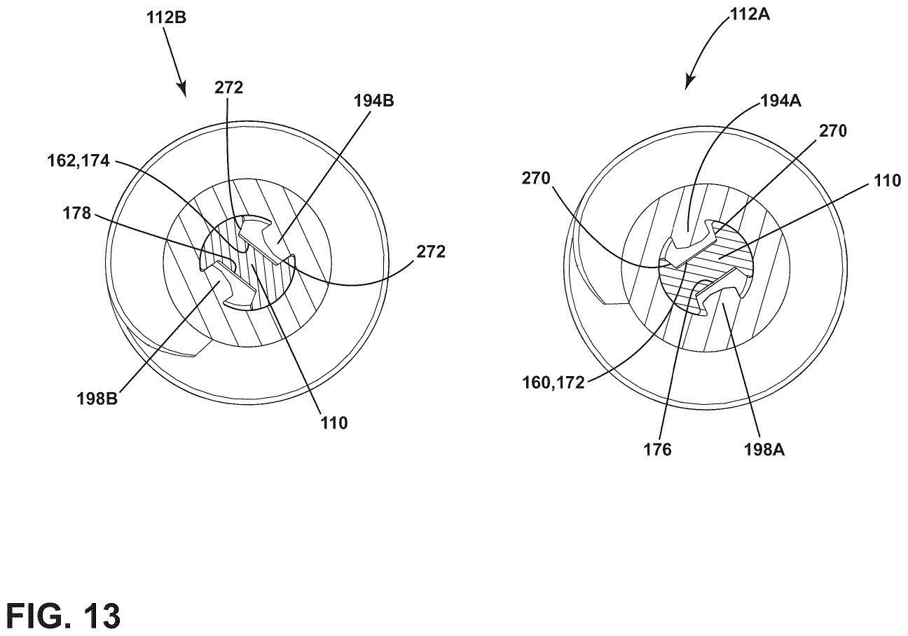

Referring to FIG. 13, in the stopped/idle state, the protrusion 194A, 194B of at least one of the first worm 112A or the second worm 112B (e.g., the protrusion 194A of the first worm 112A in FIG. 13) is disposed between and not in contact with circumferential walls 270, 272 of the rotatable shaft 110 that at least partially define the wide portion 172, 174 of the recess 160, 162, which can be the result of the spring 240 rotating the worm(s) 112A, 112B.

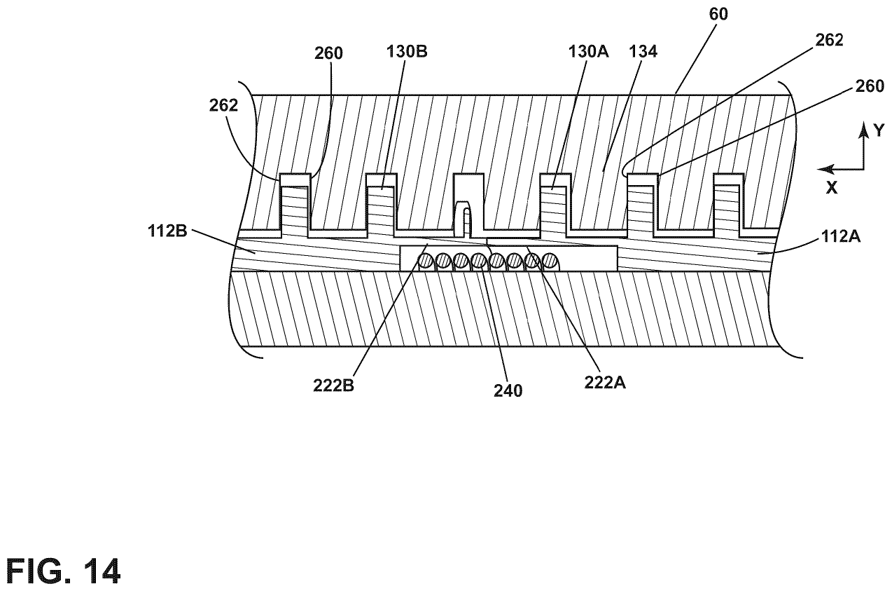

Referring to FIG. 14, when the motor 82 is operating (e.g., in an active/operating state of the drive assembly 100), the force of the motor 82 overcomes the force of the spring 240, the rotatable shaft 110 rotates to drive the worms 112A, 112B, and the worms 112A, 112B are in the second relative position. The threads 130A, 130B of the worms 112A, 112B engage the first track teeth 134, resulting in longitudinal movement of the support assembly 24 along the first track 60.

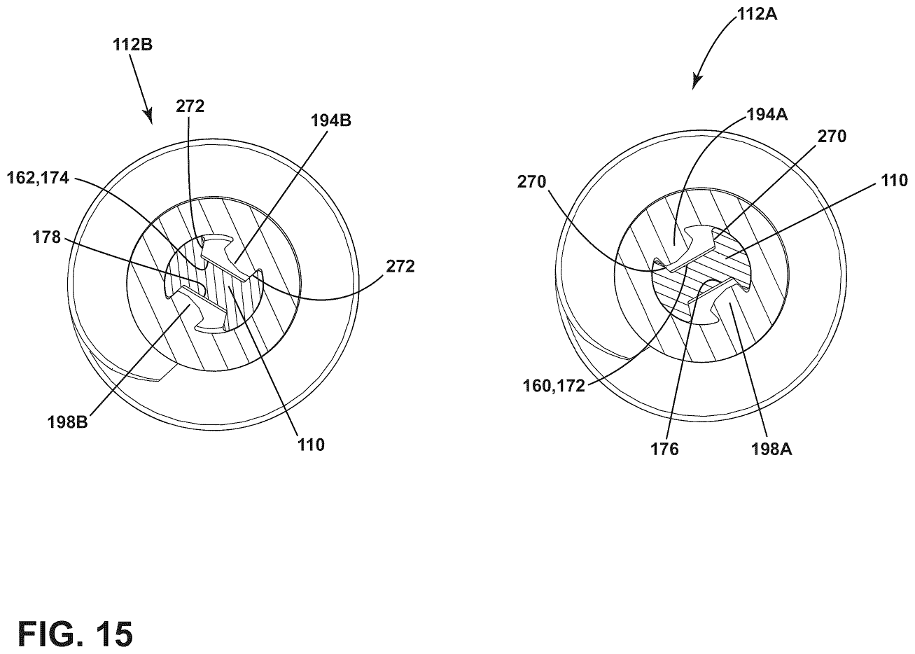

As the drive assembly 100 transitions from the stopped/idle state to the active state, initial movement of the motor 82 and the rotatable shaft 110 may not result in immediate rotation of both of the worms 112A, 112B. For example, the rotation of at least one of the worms 112A, 112B by the spring 240 can result in protrusion 194A, 194B of at least one of the worms 112A, 112B being offset from the circumferential walls 270, 272 of the recess 160, 162 (see, e.g., the first worm 112A in FIG. 13). This offset can result in the initial movement of the rotatable shaft 110 first moving a respective circumferential wall 270, 272 into contact with the respective protrusion 194A, 194B (e.g., from the configuration shown in FIG. 13 to the configuration shown in FIG. 15). Once the circumferential wall 270, 272 is in contact with the protrusion(s) 194A, 194B, such as illustrated in FIG. 15, the worm 112A, 112B will rotate with the rotatable shaft 110. When at least one circumferential wall 270, 272 of at least one recess 160, 162 is contact with and driving a respective protrusion 194A, 194B for both worms 112A, the worms 112A, 112B are in the second relative position, the pitches of the threads 130A, 130B of the worms 112A, 112B will match, the worms 112A, 112B will rotate together with the rotatable shaft 110, the threads 130A, 130B will engage successive teeth of the first track teeth 134, and the support assembly 24 will move along the first track 60.

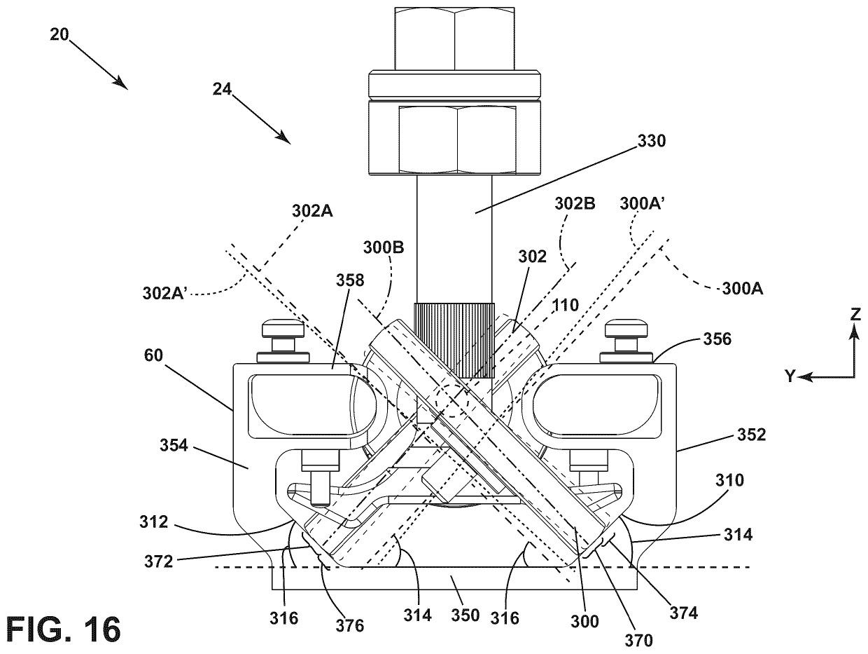

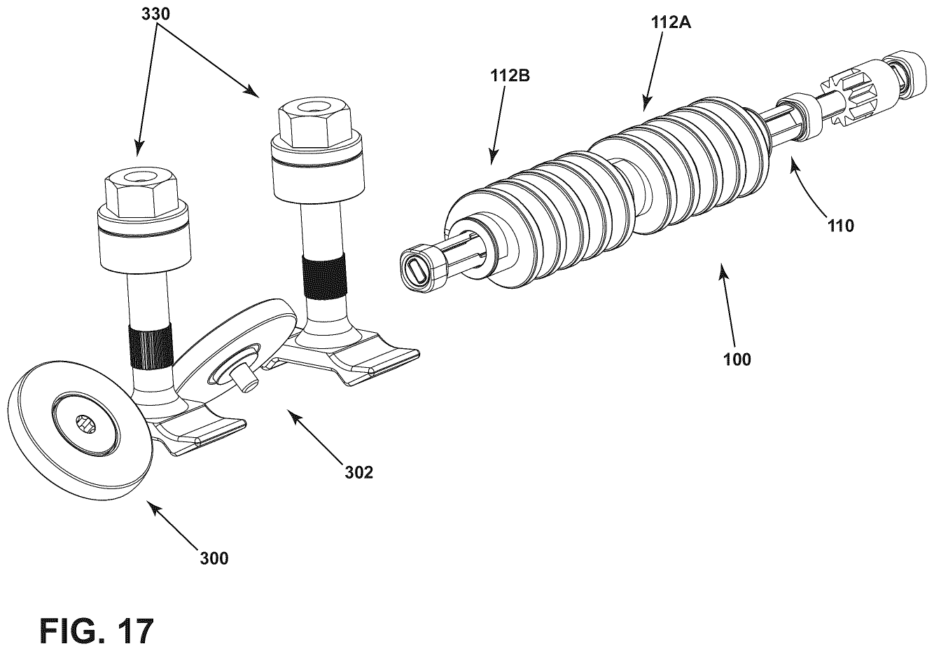

Referring to FIG. 16, the support assembly 24 can include a first wheel 300 and a second wheel 302 via which the support assembly 24 rolls along the first track 60. The first track 60 includes a first inner track surface 310 and a second inner track surface 312. The inner track surfaces 310, 312 are angled relative to the transverse and vertical directions Y, Z. For example, the inner track surfaces 310, 312 can be disposed at angles 314, 316 above the transverse direction Y that can be equal to or between 35 degrees and 55 degrees, 40 degrees and 50 degrees, or 44 degrees and 46 degrees. The first wheel 300 is in contact with the first inner track surface 310, and an axis 300A of the first wheel 300 is parallel with the first inner track surface 310 such that the axis 300A is disposed at the angle 314. The second wheel 302 is in contact with the second inner track surface 312, and an axis 302A of the second wheel 302 is parallel with the first second track surface 312 such that the axis 302A is disposed at the angle 316. The wheels 300, 302 contacting the angled inner track surfaces 310, 312 restrict movement of the support assembly 24 in the transverse direction Y, in addition to supporting the support assembly 24 in the vertical direction Z. The support assembly 24 can include additional wheels in contact with one or both of the first and second inner track surfaces 310, 312. For example, the support assembly 24 can include a first pair of wheels 300, 302 in contact with the first and second inner track surfaces 310, 312 and disposed proximate a first end of the support assembly 24, and can include a second pair of wheels 300, 302 in contact with the first and second inner track surfaces 310, 312 and disposed proximate a second end of the support assembly 24.

The support assembly 24 can include one or more anchors 330 that move with the support assembly 24 along the first track 60. The one or more anchors 330 can be fixed relative to the support assembly 24, disposed at least partially in the first track 60, and restrict movement of the support assembly 24 in the vertical direction Z.

The first track 60 can include a base wall 350, a first side wall 352, a second side wall 354, a first wing 356 extending inward from a top of the first side wall 352, and a second wing 358 extending inward from a top of the second side wall 354. The walls 350-354 can be disposed in a U-shaped configuration that opens upward in the vertical direction Z. The first wing 356 and the second wing 358 can extend toward each other in the transverse direction Y and can define a track gap 360, in the transverse direction Y, therebetween. The one or more anchors 330 can be at least partially aligned with the first wing 356 and/or the second wing 358 in the vertical direction Z to restrict and/or prevent vertical removal of the support assembly 24 from the first track 60. The first inner track surface 310 can extend from the base wall 350 to the first side wall 352. The second inner track surface 312 can extend from the base wall 350 to the second side wall 354. One or both of the wheels 300, 302 can extend into and/or beyond the track gap 360. For example, one or both of the wheels 300, 302 can be disposed partially above the wings 356, 358.

The first and second wheels 300, 302 are in contact with and roll along the first inner track surface 310 and the second outer track surface 312, respectively. In some instances, such as when the separation distance D is equal to a first value (e.g., the nominal distance), the first and second wheels 300, 302 are in contact with and roll along first portions 370, 372 of the first and second inner track surfaces 310, 312, respectively. In some other instances, such as when the separation distance D is equal to a second value (e.g., not equal to the nominal distance), the wheels 300, 302 may shift, at least to some extent, which can result in the first and second wheels 300, 302 contacting and rolling along second portions 374, 376 of the first and second inner track surfaces 310, 312. The second portions 374, 376 are at least partially offset in the transverse direction Y and/or the vertical direction Z from the first portions 370, 372. The shift of the first and second wheels 300, 302 can result from the second base portion 72 moving (e.g., rotating) via the coupling 90 relative to the support body 40. The shifting of the first and second wheels 300, 302 can result in the shifting (e.g., tilting) of the axes 300A, 302A to the positions illustrated at 300A′, 302A′.

In some configurations, a first plane 300B can extend through a center of and be parallel with the first wheel 300, and a second plane 302B can extend through a center of and be parallel with the second wheel 302. The first plane 300B is perpendicular to the first axis 300A. The second place is perpendicular to the second axis 302A. The planes 300B, 302B can intersect at a line that is parallel to the longitudinal direction and/or concentric with the rotatable shaft 110.

Referring again to FIG. 3, the support assembly 24 (e.g., the second base portion 72) can include a second drive assembly 1100 operably coupled with the second track 62. The second drive assembly 1100 can be configured in a similar or the same manner as the first drive assembly 100 in a mirrored configuration. For example, the second drive assembly 1100 can include a transmission 1102 operably coupling the motor 82 with a rotatable shaft 1110 disposed in the second track 62. Third and fourth worms 1112A, 1112B can be disposed on and movably coupled with the rotatable shaft 1110. The rotatable shaft 1110 and the worms 1112A, 1112B can be configured and operate in a similar or the same manner as the rotatable shaft 110 and the worms 112A, 112B. The worms 1112A, 1112B are engaged with second track teeth 1134 of the second track 62.

With at least some examples, operation of the motor 82 can cause movement (e.g., sliding, rolling, etc.) of the support assembly 24 along the pair of tracks 22. As the support assembly 24 moves, the second base portion 72 may rotate, via the coupling 90, relative to the support body 40, such as about an axis parallel with the longitudinal direction X. This rotation can compensate for changes/variations in the distance D between the first and second track 60, 62, which can facilitate maintaining the positions of the rotatable shaft 110 and the rotatable shaft 1110 relative to the tracks 60, 62 (e.g., parallel/aligned with the longitudinal directions X of the tracks 60, 62 and centered within the tracks 60, 62 relative to the transverse direction Y). Maintaining the positions of the rotatable shafts 110, 1110 can promote efficient operation of the drive assembly 100, 1100 when operating the motor 82 (e.g., reducing power usage associated with increased friction between the worms 112A, 112B, 1112A, 1112B and the tracks 60, 62, and increased noise associated therewith that can result from misalignment).

When the motor 82 is not operating, the movably coupled configuration of at least one of the worms 112A, 112B, where at least one worm 112A, 112B is movable (e.g., rotatable and/or slidable) relative to the movable shaft 110 and at least one worm 112A, 112B is movable relative to the other worm 112A, 112B, can provide a locking effect, via the spring 240, that reduces or eliminates play in the longitudinal direction X between the support assembly 24 and the first track 60. The worms 1112A, 1112B can be coupled in the same or a similar manner to the rotatable shaft 1110 to provide a locking effect that reduces or eliminates play between the support assembly 24 and the second track 62.

The first track teeth 134 and/or the second track teeth 1134 can include a first set of teeth 136, 1136 disposed at a first side of the track 60, 62 and a second set of teeth 138, 1138 disposed at a second side of the track 60, 62. The first and second sides can be opposite from each other in the transverse direction Y. The worms 112A, 112B, 1112A, 1112B can be engaged (e.g., simultaneously) with the first and second sets of teeth 136, 1136, 138, 1138. The first wing 356 may include and/or be at least partially defined by the first set of teeth 136. The second wing 358 may include and/or be at least partially defined by the second set of teeth 138. The rotatable shaft 110 and/or the worms 112A, 112B can be disposed at least partially in the gap 360.

The track teeth 134 (and/or track teeth 1134) can include a first portion 380 and a second portion 382. The first portion 380 can include one or more materials (e.g., metals, such as steel) that are stronger than one or more materials (e.g., plastic) of the second portion 382. During normal operation, the worms 112A, 112B may contact the second portion 382 and may or may not contact the first portion 380. If a dynamic event occurs and forces above a threshold are applied to the support assembly 24 and/or the pair of track 22, the worms 112A, 112B may contact the first portion 380.

In some configurations, one of the worms 112A, 112B can be fixed (e.g., secured, fastened, integrally formed with) relative to the rotatable shaft 110 and the other can be movable relative to the rotatable shaft 110.

The instant disclosure includes the following non-limiting embodiments:

1. A track assembly, comprising: a track including teeth; and a support assembly slidably connected to the track, the support assembly including: a rotatable shaft disposed at least partially in the track; a first worm coupled with the rotatable shaft and engaged with the teeth; and a second worm movably coupled with the rotatable shaft and movable relative to the first worm, the second worm engaged with the teeth.

2. The track assembly of any preceding embodiment, wherein the support assembly includes a motor coupled with the rotatable shaft; and the first worm and the second worm are movably coupled with the rotatable shaft such that operation of the motor rotates the rotatable shaft, which rotates at least one of the first worm or the second worm.

3. The track assembly of any preceding embodiment, wherein the support assembly includes a spring rotationally biasing the first worm and the second worm in opposite directions.

4. The track assembly of any preceding embodiment, wherein the first worm and the second worm include a first relative position and a second relative position; the spring biases the first worm and the second worm toward the first relative position; in the second relative position, threads of the first worm are aligned with threads of the second worm; and in the first relative position, the threads of the first worm are offset from the threads of the second worm.

5. The track assembly of any preceding embodiment, wherein, in the first relative position, the first worm is in contact with first axial surfaces of the teeth and the second worm is offset from the first axial surface of the teeth.

6. The track assembly of any preceding embodiment, wherein, in the first relative position, the second worm is in contact with second axial surfaces of the teeth, reducing or eliminating play between the support assembly and the track.

7. The track assembly of any preceding embodiment, wherein the spring is disposed at least partially in the first worm and/or the second worm.

8. The track assembly of any preceding embodiment, wherein the spring includes a torsion spring and is wrapped at least partially around the rotatable shaft.

9. The track assembly of any preceding embodiment, wherein the first worm is movably coupled with the rotatable shaft such that the first worm can rotate with the rotatable shaft and relative to the rotatable shaft.

10. The track assembly of any preceding embodiment, wherein the rotatable shaft includes a recess; the first worm includes a protrusion disposed at least partially in the recess; and the recess has at least one dimension that is larger than a corresponding dimension of the protrusion.

11. The track assembly of claim any preceding embodiment, wherein the rotatable shaft includes a second recess; the second worm includes a second protrusion disposed at least partially in the second recess; and the second recess has at least one dimension that is larger than a corresponding dimension of the second protrusion.

12. The track assembly of claim any preceding embodiment, wherein the at least one dimension includes a circumferential dimension.

13. The track assembly of claim any preceding embodiment, further comprising a second track including a plurality of second teeth; wherein the support assembly is slidably connected to the track and the second track; and the support assembly includes: a support body; a first base portion rigidly connected to the support body and slidably connected to the track; and a second base portion movably connected to the support body and slidably connected to the second track.

14. The track assembly of any preceding embodiment, wherein: the first base portion includes the rotatable shaft, the first worm, and the second worm; and the second base portion includes: a second rotatable shaft disposed at least partially in the second track; a third worm movably coupled with the second rotatable shaft and engaged with the plurality of second teeth; and a fourth worm movably coupled with the second rotatable shaft and movable relative to the third worm, the fourth worm engaged with the plurality of second teeth.

15. The track assembly of any preceding embodiment, wherein a movable connection between the second base portion and the support body is configured to compensate for variations in a separation distance between the track and the second track to reduce variations in an angle of the rotatable shaft relative to a longitudinal direction the track and in a second angle of the second rotatable shaft relative to the longitudinal direction.

16. The track assembly of any preceding embodiment, wherein the wheel is configured roll along a first portion of the track when the separation distance has a first value and a second portion of the track when the separation distance has a second value.

17. The track assembly of any preceding embodiment, wherein at least one of the first worm or the second worm is movably coupled with the rotatable shaft to translate along the rotatable shaft; and the teeth of the track include a first set of teeth disposed a first side of the track and a second set of teeth disposed a second side of the track; and the first worm is engaged with the first set of teeth and the second set of teeth.

18. A track assembly, comprising: a first track; a second track; and a support assembly slidably connected to the first track and the second track, the support assembly including: a support body; a first base portion rigidly connected to the support body and slidably connected to the first track; and a second base portion movably connected to the support body and slidably connected to the second track.

19. The track assembly of any preceding embodiment, wherein the first track includes first teeth; the second track includes second teeth; and the first base portion includes: a first rotatable shaft disposed at least partially in the first track; a first worm coupled with the first rotatable shaft and engaged with the first teeth; and a second worm coupled with the first rotatable shaft and movable relative to the first worm, the second worm engaged with the first teeth; and at least one of the first worm or the second worm is movably coupled with first rotatable shaft to move with and relative to the first rotatable shaft.

20. The track assembly of any preceding embodiment, wherein a movable connection between the second base portion and the support body is configured to compensate for variations in a separation distance between the first track and the second track to reduce variations in a first angle of the first rotatable shaft relative to a longitudinal direction of the first track; and the movable connection allows for relative rotation between the second base portion and the support body about a rotational axis that is parallel with a longitudinal direction of the second track.

21. The track assembly of any preceding embodiment, wherein the support assembly comprises a vehicle seat.

22. The track assembly of any preceding embodiment, wherein the support assembly is not vertically removable from the track.

23. The track assembly of any preceding embodiment, wherein the support assembly includes a plurality of angled wheels in contact with angled portions of the track to restrict transverse movement of the rotatable shaft.

24. The track assembly of any preceding embodiment, wherein the track is equal to or between two meters and three meters long.

25. A vehicle including the track assembly of any preceding embodiment.

In examples, a controller may be communicatively coupled to and/or at least partially control one or more portions of the track assembly 20, such as the motor 82. The controller may include an electronic controller and/or include an electronic processor, such as a programmable microprocessor and/or microcontroller. In embodiments, a controller may include, for example, an application specific integrated circuit (ASIC). A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in some examples,” “with some examples,” “various embodiments,” “with some embodiments,” “in some embodiments,” “an embodiment,” “with some configurations,” “in some configurations,” or the like, means that a particular feature, structure, or characteristic described in connection with the example/embodiment/configuration is included in at least one embodiment. Thus, appearances of the phrases “examples, “in some examples,” “with some examples,” “in various embodiments,” “with some embodiments,” “in some embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example/configuration may be combined, in whole or in part, with the features, structures, functions, and/or characteristics of one or more other embodiments/examples/configurations without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “set” or a “set” of elements can be any number of elements, including only one.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. It will be further understood that the terms “includes.” “including,” “comprises.” and/or “comprising.” when used in this application, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A track assembly, comprising:
a track including teeth; and
a support assembly slidably connected to the track, the support assembly including:
a rotatable shaft disposed at least partially in the track;
a first worm coupled with the rotatable shaft and engaged with the teeth; and
a second worm coupled with the rotatable shaft and movable relative to the first worm, the second worm engaged with the teeth.

2. The track assembly of claim 1, wherein the support assembly includes a motor coupled with the rotatable shaft; and
the first worm and the second worm are movably coupled with the rotatable shaft such that operation of the motor rotates the rotatable shaft, which rotates at least one of the first worm or the second worm.

3. The track assembly of claim 1, wherein the support assembly includes a spring rotationally biasing the first worm and the second worm in opposite directions.

4. The track assembly of claim 3, wherein the first worm and the second worm include a first relative position and a second relative position;
the spring biases the first worm and the second worm toward the first relative position;
in the second relative position, threads of the first worm are aligned with threads of the second worm; and
in the first relative position, the threads of the first worm are offset from the threads of the second worm.

5. The track assembly of claim 4, wherein, in the first relative position, the first worm is in contact with first axial surfaces of the teeth and the second worm is offset from the first axial surface of the teeth.

6. The track assembly of claim 5, wherein, in the first relative position, the second worm is in contact with second axial surfaces of the teeth, reducing or eliminating play between the support assembly and the track.

7. The track assembly of claim 3, wherein the spring is disposed at least partially in the first worm and/or the second worm.

8. The track assembly of claim 7, wherein the spring includes a torsion spring and is wrapped at least partially around the rotatable shaft.

9. The track assembly of claim 1, wherein the first worm is movably coupled with the rotatable shaft such that the first worm can rotate with the rotatable shaft and relative to the rotatable shaft.

10. The track assembly of claim 9, wherein the rotatable shaft includes a recess;
the first worm includes a protrusion disposed at least partially in the recess; and
the recess has at least one dimension that is larger than a corresponding dimension of the protrusion.

11. The track assembly of claim 10, wherein the rotatable shaft includes a second recess;
the second worm includes a second protrusion disposed at least partially in the second recess; and
the second recess has at least one dimension that is larger than a corresponding dimension of the second protrusion.

12. The track assembly of claim 10, wherein the at least one dimension includes a circumferential dimension.

13. The track assembly of claim 1, further comprising a second track including a plurality of second teeth;
wherein the support assembly is slidably connected to the track and the second track; and
the support assembly includes:
a support body;
a first base portion rigidly connected to the support body and slidably connected to the track; and
a second base portion movably connected to the support body and slidably connected to the second track.

14. The track assembly of claim 13, wherein:
the first base portion includes the rotatable shaft, the first worm, and the second worm; and
the second base portion includes:
a second rotatable shaft disposed at least partially in the second track;
a third worm movably coupled with the second rotatable shaft and engaged with the plurality of second teeth; and
a fourth worm movably coupled with the second rotatable shaft and movable relative to the third worm, the fourth worm engaged with the plurality of second teeth.

15. The track assembly of claim 14, wherein a movable connection between the second base portion and the support body is configured to compensate for variations in a separation distance between the track and the second track to reduce variations in an angle of the rotatable shaft relative to a longitudinal direction of the track and in a second angle of the second rotatable shaft relative to the longitudinal direction.

16. The track assembly of claim 15, wherein a wheel is configured roll along a first portion of the track when the separation distance has a first value and a second portion of the track when the separation distance has a second value.

17. The track assembly of claim 1, wherein at least one of the first worm or the second worm is movably coupled with the rotatable shaft to translate along the rotatable shaft; and
the teeth of the track include a first set of teeth disposed at a first side of the track and a second set of teeth disposed at a second side of the track; and
the first worm is engaged with the first set of teeth and the second set of teeth.

18. A track assembly, comprising:
a first track;
a second track; and
a support assembly slidably connected to the first track and the second track, the support assembly including:
a support body;
a first base portion rigidly connected to the support body and slidably connected to the first track; and
a second base portion movably connected to the support body and slidably connected to the second track.

19. The track assembly of claim 18, wherein the first track includes first teeth;
the second track includes second teeth; and
the first base portion includes:
a first rotatable shaft disposed at least partially in the first track;
a first worm coupled with the first rotatable shaft and engaged with the first teeth; and
a second worm coupled with the first rotatable shaft and movable relative to the first worm, the second worm engaged with the first teeth; and
at least one of the first worm or the second worm is movably coupled with first rotatable shaft to move with and relative to the first rotatable shaft.

20. The track assembly of claim 19, wherein a movable connection between the second base portion and the support body is configured to compensate for variations in a separation distance between the first track and the second track to reduce variations in a first angle of the first rotatable shaft relative to a longitudinal direction of the first track; and
the movable connection allows for relative rotation between the second base portion and the support body about a rotational axis that is parallel with a longitudinal direction of the second track.
